(19) United States
(12) Patent Application Publication
(10) Pub. No.: US 2007/0124085 A1
(43) Pub. Date: May 31, 2007

(54) Method of processing a biological image

(76) Inventors: Geert Kalusche, Whitchurch (GB); Nicholas Thomas, Whitchurch (GB)

Correspondence Address: Amersham Biosciences Corp, 800 Centennial Avenue, Piscataway, NJ, 08855, US

(21) Appl. No.: 11/290,693

(22) Filed: Nov. 30, 2005

(51) Int. Cl. G06F 19/00

(52) U.S. Cl. 702/20

(57) ABSTRACT

A method of processing an image of a biological sample containing nuclei, cytoplasm and micronuclei, each of the nuclei being surrounded by cytoplasm, determines the incidence of micronuclei in the sample. The cytoplasm has a maximum distance, which is the largest extent of the cytoplasm from its nucleus occurring in the image. The method includes the steps of setting a search distance at a value less than the maximum distance, searching for micronuclei within the search distance from the nuclei and annotating the micronuclei found in the search.

### FIELD OF THE INVENTION

The invention relates to a method of processing an image of a biological sample containing nuclei, cytoplasm and micronuclei. The invention further relates to a computer programme performing the method, a data carrier comprising the computer programme and a system arranged to run the computer programme.

### BACKGROUND OF THE INVENTION

The processing of images is of particular relevance in the field of biology, where images of biological samples are to be analysed for the presence of certain features. The features may include intracellular components, fibres, and granules. When using fluorescent microscopy, the distribution of elements in the samples labelled with a fluorophore can be imaged and stored as intensity values of pixels in a digital image. Different elements can be labelled with different fluorophores, which allows imaging a specific element by choosing an appropriate wavelength for illumination of the sample and an appropriate filter for collecting the radiation from the sample. A specific combination of wavelength and filter is called a channel. For example, a first channel may be set for imaging nuclei of cells and a second channel for imaging cytoplasm surrounding the nuclei.

In the field of drug discovery the images of a large number of biological samples have to be processed. The method of processing must provide for a fast execution on a computer to allow handling of a complete assay in a reasonable time. A particular drug discovery assay looks at micronucleus induction for finding genotoxic compounds. Analysis of micronucleus formation is an important component of toxicology evaluation of new drug candidates and other chemicals and materials, such as food dyes and cosmetics that are intended for human consumption or use or which may be indirectly or accidentally consumed or ingested. The analysis determines the incidence of micronuclei in the cytoplasm of cells and, preferably, the attribution of the micronuclei with mononucleate cells and binucleate cells.

Known automated methods of analysing the incidence of micronuclei are relatively slow. One of the known methods uses an image from a first channel to locate nuclei in the sample, identifies the cytoplasm in an image from a second channel and segments the cytoplasm from the background by a watershed method, and, subsequently, determines the presence of micronuclei in the area of the cytoplasm in the image from the first channel. The segmentation of the cytoplasm and the use of the second channel require a substantial amount of time. It is an object of the invention to provide a faster method.

### SUMMARY OF THE INVENTION

The object of the invention is achieved in a method of processing an image of a biological sample containing nuclei, cytoplasm and micronuclei, each of the nuclei being surrounded by cytoplasm, the cytoplasm having a maximum distance, which is the largest extent of the cytoplasm from its nucleus occurring in the image, the method including the steps of setting a search distance at a value less than the maximum distance, searching for micronuclei within the search distance from the nuclei and annotating the micronuclei found in the search.

The method according to invention avoids the use of the watershed segmentation and can operate on the image of a single channel. The maximum distance is the largest value of the extent of the cytoplasm from the nucleus which it surrounds occurring in the image. A search is carried out for micronuclei having a distance of less than the second distance from the edge of a nucleus. Such micronuclei are in general located in the cytoplasm surrounding the nucleus. Micronuclei complying with this requirement are annotated as a find of the search. The method allows the attribution of micronuclei to specific cells, such as mononucleate cells and binucleate cells.

Although micronuclei are in general located relatively close to the edge of the nucleus, micronuclei that are located in the cytoplasm at a distance larger than the second distance may be discarded by the method according to the invention. This does not affect an analysis based on relative incidences, for example an analysis focused on the increase of micronuclei incidents as a function of the concentration of a genotoxic compound. When absolute instances are acquired, reference samples with known incidences may be used to scale the incidences obtained by the method according to the invention.

In a first preferred embodiment of the method it includes the step of defining a first area around at least one of the nuclei, the first area being enclosed between an inner boundary and an outer boundary, the distance between an edge of the first element and the outer boundary being substantially equal to the search distance, and the search for micronuclei being carried out within a search area restricted by the first area. The shape of the search area is such that it follows the edge of the nucleus. The search for micronuclei will in general extend to all nuclei in the entire image. The computation of the search areas can be done substantially faster than the prior art determination of the extent of the cytoplasm with the watershed method. The search for micronuclei in the search areas around the nuclei in the image can be carried out in the same channel as the identification of the nuclei and can also be performed relatively fast.

In an alternative method the search distance is set at a value substantially equal to half the diameter of the nucleus to which the search area pertains. The word ‘substantially’ means that the value is preferably between 0.3 and 0.7 times the diameter. When the shape of the nucleus is not circular, the diameter can be calculated as the average of the longest and shortest diameter of the nucleus. The diameter may also be averaged over the nuclei to be investigated.

In a special embodiment the inner boundary of the search area is the edge of the nucleus. Since the edge of the nucleus has already been determined in the identification of the nuclei, the determination of the inner boundary does not require more calculations. In another preferred method the inner boundary of the first area is arranged outside the nucleus and inside the outer boundary. A dilation of the inner boundary from the edge of the nucleus avoids that variations in staining intensity at the edge are incorrectly identified as micronuclei. When the outer boundary is defined in terms of a certain distance from the inner boundary, the search distance is equal to this distance plus the distance between the inner boundary and the edge of the nucleus.

The method may be refined by the step of defining a second area around the nucleus, the second area being a region of overlap of the first area and the area of the cytoplasm surrounding the nucleus, the search area being restricted by the second area. This prevents the search area from falling outside of the region of the cell and avoids annotating objects outside cells as micronuclei. The extent of the cytoplasm can be determined in a second channel, different from the channel used for identifying the nuclei and micronuclei, where a fast-executing thresholding may be used to identify the cytoplasm.

When nuclei are relatively close, a search area surrounding one nucleus may overlap with part of a neighbouring nucleus. To avoid identification of the area of overlap as a micronucleus, the search area is preferably restricted to the first or second area excluding the region of overlap with neighbouring nuclei.

It should be noted that the U.S. Pat. No. 5,989,835 discloses a method of locating reporter molecules in cells. The method defines a nuclear mask within the area of a cell nucleus and a sampling area around the nucleus, both in an image of a first channel. The presence of reporter molecules is determined in an image of another channel by measuring the average fluorescence in the nuclear mask and the sampling area. The patent does not disclose the use of a search area for determining the presence of discrete objects such as micronuclei. It neither discloses a search for objects in an image from the same channel as the one in which the areas are defined, providing a considerable advantage in processing speed, nor a search area close to the nucleus, where it is most likely to find micronuclei.

In a second preferred embodiment of the method it includes the step of determining a third distance between at least one of the micronuclei and the nearest nucleus, and annotating the micronucleus when the third distance is less than the search distance. The method searches the image for objects having the size and intensity of a micronucleus, determines the distance to the nearest nucleus and annotates the micronucleus as a find only when the distance is less than the search distance. The method of this second preferred embodiment can execute very fast and is simple to implement.

In an alternative method the search distance is set at a value substantially equal to half the diameter of the nuclei. The word ‘substantially’ means that the value is preferably between 0.3 and 0.7 times the diameter. When the shape of the nucleus is not circular, the diameter can be calculated as the average of the longest and shortest diameter of the nucleus. The diameter is preferably averaged over the nuclei to be investigated.

To prevent a micronucleus from being located outside a cell, the method preferably includes the step of annotating the micronucleus only when it overlaps the cytoplasm surrounding the nearest nucleus. The extent of the cytoplasm can be determined as set out above.

A second aspect of the invention relates to a computer program arranged to perform the method of the invention.

A third aspect of the invention relates to a data carrier in which the computer program is stored.

A fourth aspect of the invention relates to a system, preferably an analyzer system, including a processing unit for running the computer program. The system includes preferably a data carrier in which the computer program is stored.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows the formation of a micronucleus during cell division.

FIG. 2 shows a schematic view of a fluorescence microscope used to image samples.

FIG. 3 shows a schematic illustration of data processing components of a system.

FIG. 4 shows a flow diagram of a first preferred embodiment of the method of processing an image according to the invention.

FIG. 5 shows schematically nuclei with search areas.

FIG. 6 shows a flow diagram of a second preferred embodiment of the method of processing an image according to the invention.

FIG. 7 shows schematically nuclear objects.

### DETAILED DESCRIPTION OF THE INVENTION

Micronucleus induction is a key characteristic of genotoxic compounds. The analysis of micronucleus formation is therefore an important object of investigation. Micronuclei formation occurs during cell division of cells exposed to genotoxic compounds. This may be the result of either DNA strand breakage due to clastogenic compounds or of erroneous chromosome segregation caused by interference with components of the cell's chromosome separation machinery, such as tubulin, due to aneugenic compounds.

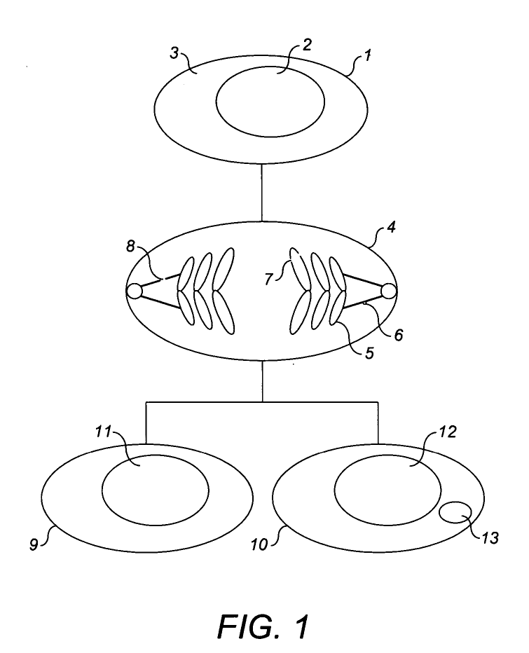

FIG. 1 shows the formation of a micronucleus during cell division, also called mitosis. A cell 1 comprises a nucleus 2 surrounded by cytoplasm 3. The cell during division is represented by reference numeral 4. The divided chromosomes 5 are separated by microtubules 6. The Figure shows a DNA strand breakage 7 and a breakage 8 of a microtubule. These defects in the chromosome segregation result in chromosome fragments or whole chromosomes. After cytokinesis, i.e. the splitting of the cell into two daughter cells each comprising a set of segregated chromosomes, there are two cells 9, 10 each having a nucleus 11, 12. The chromosome fragments or whole chromosomes caused by the defect reside as a micronucleus 13 in the cytoplasm of cell 10. A cell containing a single nucleus, such as cells 9 and 10 in FIG. 1, are called mono-nucleate cells. A cell in which no cytokinesis has taken place after mitosis and containing two nuclei within the cytoplasm is called a bi-nucleate cell.

In-vitro micronucleus assays are performed by incubating cells with test compounds for a sufficient period to allow one or more rounds of cell division to occur to allow the formation of micronuclei where test compounds have clastogenic or aneugenic activity. Since cell division is a requirement for micronucleus formation, it is necessary to ensure that cells are actively dividing during the course of the assay. A number of approaches are available to achieve confirmation of cell division, including the use of cytokinesis blockage using cytochalasin B. In protocols employing cytochalasin B inhibition of cytokinesis, addition of the inhibitor arrests cells immediately prior to separation of daughter cells, resulting in the formation of bi-nucleate cells. Consequently analysis of a cell population treated with a test compound for the relative frequency of mononucleate and binucleate cells provides a measure of the proliferative activity of the culture. This proliferation index can be used to identify compounds which cause cell cycle delay or arrest, and to indicate the need to retest compounds where there is a risk of a false negative assay result arising from compound cytotoxicity. For guidance on proliferation controls and use of cytokinesis blockage, see the ‘Report from the in-vitro micronucleus assay working group’ by M. Kirsch-Volders et al in the journal Mutat. Res. 2003, Vol. 540(2), page 153-163.

The presence of micronuclei can be readily detected using standard DNA staining methods and fluorescence imaging. Common stains for DNA are Hoechst™ 33342 and DRAQ5™. Cytoplasm can be stained using FITC or Calcein blue AM. Non-viable cells can be detected by using the stain Propidium iodide. The samples for the assay are prepared in a conventional way. Samples containing different amounts of the test compound may be deposited in the wells of a microtiter plate.

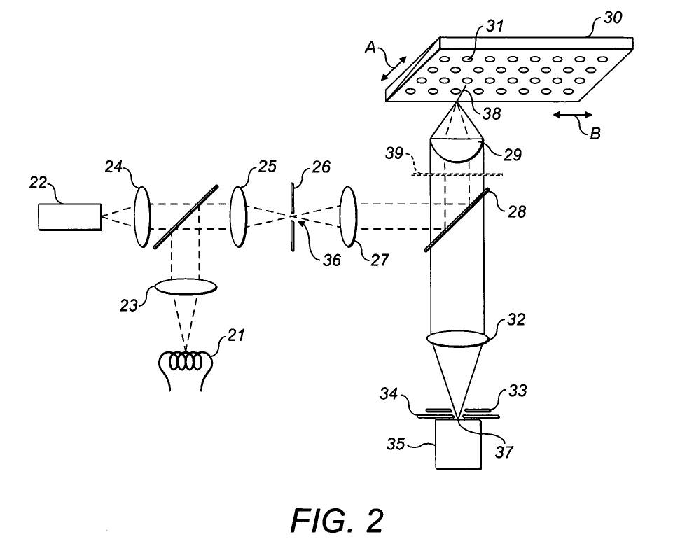

FIG. 2 shows a schematic view of a fluorescence microscope which can be used to image the above samples in an analyzer system such as the GE Healthcare IN Cell Analyzer 3000 system, disclosed in U.S. Pat. No. 6,400,487 and U.S. Pat. No. 6,388,788. The microscope comprises a source of electromagnetic radiation, for example a light bulb 21 and/or a laser 22 emitting radiation in the optical range, 350-750 nm, which is collimated by lenses 23 and 24, respectively. The microscope further comprises a cylindrical lens 25, a first slit mask 26, a first relay lens 27, a beam splitter 28 in the form of a dichroic mirror, an objective lens 29, a microtiter plate 30 containing a two-dimensional array of sample wells 31, a tube lens 32, a filter 33, a second slit mask 34 and a detector 35. These elements are arranged along the optical axis OA defined by slit apertures 36, 37 in masks 26, 34, respectively, and extending perpendicular to the plane of FIG. 2. The focal lengths of lenses 27, 29 and 32 and the spacings between these lenses as well as the spacings between mask 26 and lens 27, between objective lens 29 and microtiter plate 30 and between lens 32 and mask 34 are such as to provide a confocal microscope.

In this embodiment, the electromagnetic radiation from the source is focused to a line using the cylindrical lens 25. The shape of the line is optimized by the first slit mask 26. The slit mask 26 is shown in a plane of the optical system that is conjugate to the plane of the microtiter plate 30. The illumination stripe formed by the aperture 36 in the slit mask 26 is relayed by lens 27, dichroic mirror 28 and objective lens 29 onto the microtiter plate 30. For convenience of illustration, the optical elements are depicted in cross-section and the well plate in perspective. The projection of the line of illumination onto well plate 30 is depicted by a line 38. As indicated by arrows A and B, well plate 30 may be moved in two directions (x, y) parallel to the directions of the array by means not shown.

Alternatively, the slit mask 26 may be arranged in a Fourier plane of the optical system, which is in a plane conjugate to the back focal plane (BFP) 39 of the objective lens 29. In this case the slit aperture 36 lies in the plane of the figure, the lens 27 relays the illumination stripe formed by the aperture 26 onto the back focal plane 39 of the objective 29, which transforms it into a line in the plane of the microtiter 30 perpendicular to the plane of FIG. 1.

The radiation from the source may also be focused into the back focal plane 39 of the objective lens 29 without use of the slit mask 26. This can be accomplished by the combination of the cylindrical lens 25 and the spherical lens 27 as shown in FIG. 2, or the illumination can be focused directly into the plane 39 by the cylindrical lens 25.

An image of the sample area, for example a sample present in the sample well 31, is obtained by positioning the microtiter 20 such that the line 38 of illumination is arranged across the sample, imaging the fluorescence emission from the sample onto detector 35 and translating the plate 30 in a direction perpendicular to the line of illumination, synchronously with the reading of the detector 35. The fluorescence emission is collected by the objective lens 29, projected through the beam splitter 28, and imaged by lens 32 through filter 33 and the second slit mask 34 onto the detector 35, such as is appropriate to a confocal imaging system having an infinity-corrected objective lens 29. The beam splitter 28 and filter 33 preferentially block light at the illumination wavelength. The detector 35 may be a CCD array; the detector may be either one dimensional or two dimensional. If a one dimensional detector is used, slit mask 34 is not required. The illumination, detection and translation procedures are continued until the prescribed area has been imaged. Mechanical motion of the microtiter is simplified if it is translated at a continuous rate. Continuous motion is most useful if the camera read-time is small compared to the exposure-time. In a preferred embodiment, the camera is read continuously. The displacement d of the sample during the combined exposure-time and read-time may be greater than or less than the width of the illumination line W, exemplarily 0.5 W ≦d ≦5 W. All of the wells of a multi-well plate can be imaged in a similar manner. However, it will be recognized that a non-confocal microscope can also be used, e.g. as incorporated in the GE Healthcare IN Cell Analyzer 1000 system, disclosed in U.S. Pat. Nos. 6,563,653 and 6,345,115. Other embodiments of fluorescence microscopes that may be used to acquire the images are disclosed in the international patent application publication number WO00/235474.

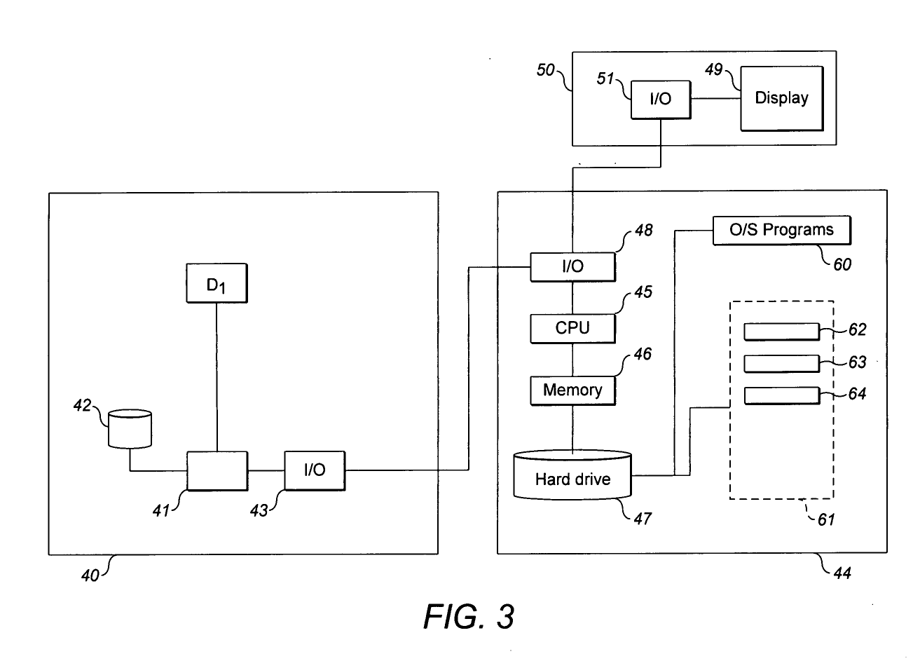

FIG. 3 shows a schematic illustration of data processing components of an analyzer system. The system includes a cell analysis system 40, based on the GE Healthcare IN Cell Analyzer system. The cell analysis system 40 includes detector D₁, which may be a detector 35 of a microscope as shown in FIG. 2. The cell analysis system 40 further comprises a control unit 41, an image data store 42 and an Input/Output (I/O) device 33.

An associated computer terminal 44 includes a central processing unit (CPU) 45, memory 46, a data storage device such as a hard disc drive 47 and I/O devices 48 which facilitate interconnection of the computer with the cell analysis system 40 and interconnection of the computer with a display element 49 of a screen 50 via a screen I/O device 51, respectively. Operating system programs 60, such as Microsoft Windows 2000™ or Windows XP™, are stored on the hard disc drive 47, and control, in a known manner, low level operation of the computer terminal 44. Program files and data 61 are also stored on the hard disc drive 47, and control, in a known manner, outputs to an operator via associated devices and output data stored on the hard disc drive. The associated devices include the display 49 as an element of the screen 50, a pointing device (not shown) and a keyboard (not shown), which receive input from, and output information to, the operator via further I/O devices (not shown). Included in the program files 61 stored on the hard disc drive 47 are an image processing and analysis application 62, an assay control application 63, and a database 64 for storing image data received from the cell analysis system 40 and output files produced during data processing. The image processing and analysis application 52 includes image processing and analysis software packages. A method according to an embodiment of the invention may be implemented as software within the image processing and analysis application 62.

The performance of a scan using the cell analysis system 40 is controlled using control application 63, and the image data are acquired. In an embodiment, the control application acts in concert with an autofocus system of the microscope shown in FIG. 2. After the end of acquisition of image data for at least one well in a microtiter plate by the detector D1, the image data are transmitted to the computer 44 and stored in the database 64 on the computer terminal hard disc drive 47, at which point the image data can be processed using the image processing and analysis application 62.

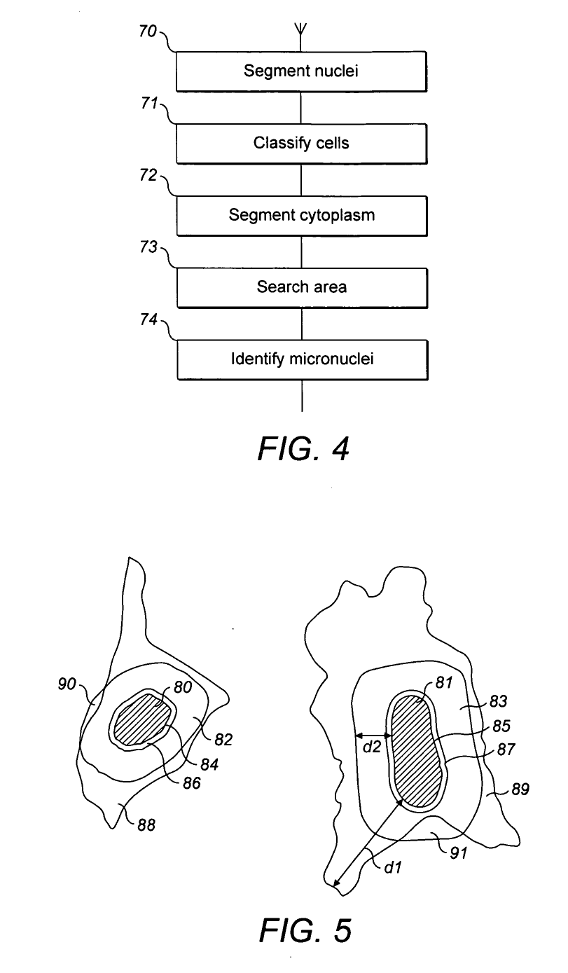

FIG. 4 shows a flow diagram of a method of processing an input image of a biological specimen according to the first preferred embodiment. The image being processed first is taken from the channel pertaining to the fluorophore used to label the nuclei. In the first step 70 of the method the nuclei are segmented. The segmentation may be carried out using thresholding, which is a relatively fast procedure. The intensity of an object in the image is an indicator of the DNA content of the object. The threshold for the intensity is set by the operator of the analyzer system at a value that clearly reveals the nuclei. An object is labelled as a nucleus when it has an intensity above the threshold intensity and a size larger than an operator-set minimum threshold size and less than a maximum threshold size. The minimum threshold size is usually set at ⅓ of the average size of the nuclei, thereby avoiding that micronuclei are identified as nuclei. FIG. 5 shows schematically an image of a biological sample in which two objects 80 and 81 are identified as nuclei.

In the second step 71 of the processing the cells found in the image are classified. Micronucleus assays usually distinguish mononucleate and binucleate cells. Mononucleate objects have a higher form factor than binucleate objects. A threshold form factor is set by the operator of the analyzer system. The operator may use a plot of the form factor versus the intensity to set the threshold at the optimum value. The form factor is the ratio of the shortest diameter of an object over its longest diameter Nuclei having a form factor larger than the threshold are labelled as mononucleate and nuclei having a lower form factor are labelled as binucleate. Nuclei that do not comply with specific requirements, such as the requirement that the cell must be alive, may not be labelled as mono- or binucleate objects and are excluded from further processing. Nucleus 80 in FIG. 5 is classified as mononucleate and nucleus 81 as binucleate.

The third step 72 of the processing is an optional step in which the extent of the cytoplasm surrounding the nucleus is established. The extent of the cytoplasm is determined in an image of a second channel pertaining to the marker of the cytoplasm. The area of the cytoplasm may be determined by thresholding the image using an operator-set threshold. The threshold is set by visual inspection making the assigned edge of the cytoplasm a reasonable approximation of the visible cytoplasm.

The search area 82, 83 around each labelled nucleus 80, 81 is defined in the fourth step 73. The search area is equal to a first area having an inner boundary and an outer boundary. The inner boundary may be the edge 84, 85 of the nucleus. The inner boundary may also extend beyond the edge of the nucleus into the surrounding cytoplasm by dilating the edge by a few pixels. The dilation is small compared to the size of the nucleus, typically 1-3 pixels for a nucleus having a maximum diameter between 10 and 30 pixels. The size of the nucleus measured in pixels depends on the cell type and the analyzer system; for CHO cells on the IN Cell 3000 system a nucleus is around 10 to 15 pixels maximum diameter and a double nucleus such as found in bi-nucleate cells 20 to 30 pixels. If erosion is previously used to define the area of the nucleus, the dilation must be by a higher value to ensure that the search area is in the cytoplasm. The extended inner boundary is shown in FIG. 5 as elements 86 and 87.

The outer boundary must be determined such that the distance between the outer boundary and the edge of the nucleus is equal to an operator-set search distance ds. The search distance is restricted by the maximum distance of the cytoplasm in the image. The nuclei 80 and 81 in FIG. 5 are surrounded by cytoplasm 88 and 89, respectively. The largest extent of cytoplasm 89 is indicated by the line d1. The longest length of line d1 of the labelled nuclei present in the area of interest of the image is called the maximum distance. The search distance must be smaller than the value of the maximum distance. The search distance must neither be too small, which will cause missing too many micronuclei in the cytoplasm, nor too large, thereby annotating objects outside the cytoplasm. A search distance equal to half the average diameter of the nucleus is a typical setting for many samples, i.e. a diameter of the outer boundary equal to twice the diameter of the nucleus. The outer boundary is set in practice by dilating the inner boundary or the edge of the nucleus. In many practical cases the search distance is equal to 11 pixels. This setting can also be used as a first setting, from where the search distance may be optimised. The value of the search distance may be determined in various ways, for example it may be taken from a database or be determined using an overlay of the search area with the cytoplasm.

The search area may, optionally, be restricted by a second area which overlays the cytoplasm. The bitmap of the cytoplasm may be overlaid with the image containing the search areas. Any area 90, 91 of the search area falling outside the area of the cytoplasm is removed from the search area. The bitmap may also be used to visualize the relation between the outer boundary of the search area and the extent of the cytoplasm. Another way of restricting the search area is to overlay the intensity image of the cytoplasm with the image containing the search areas. Any area of the first area 82, 83 that has a cytoplasm intensity lower than an operator-set minimum marking threshold is excluded from the search area, resulting in a second area. The search area is restricted by the second area.

The search area may be further restricted in situations where the density of cells is so large that the search area of a nucleus overlaps the area of one or more neighbouring nuclei. Such an area of overlap might falsely be identified as a micronucleus. In an overlay of an image of the nuclei and the search areas, all areas of overlap can be excluded from the search area.

Cells in areas of the image having a high density of cells may be excluded from the micronucleus search because of the increased risk of false identification of objects as mono-nucleate cells and bi-nucleate cells.

An optional restriction of the cells being processed involves the exclusion of non-viable or dead cells. The viability of cells is determined in an image of a third channel pertaining to the Propidium iodide marker. Any cell having an average intensity between an operator-set minimum value and an operator-set maximum value are identified as dead and cells having an average intensity outside the range are identified viable. The dead cells are excluded from further processing and the search is restricted to living cells.

The fifth step 74 of the processing identifies the micronuclei. An object within the search area having an intensity larger than an operator-set threshold intensity and falling between an operator-set minimum size value and an operator-set maximum size value is annotated as a micronucleus.

Since each search area belongs to a particular nucleus, the micronuclei found during the search can also be attributed to nuclei. This allows attribution of micronuclei to mono-nucleus cells and to bi-nuclei cells, which can advantageously be used in the toxicity analysis of the test compound.

When the search areas overlap, a micronucleus found in the area of overlap can be attributed to the first nucleus in which cytoplasm it is discovered. This attribution depends on the method of scanning the search areas of the nuclei. One method is to scan the image line-wise first from left to right and then from top to bottom.

Another method of solving the problem of overlapping search areas is to construct a dividing line between the neighbouring nuclei at equal distance from the edges of both nuclei. The search areas of both nuclei are restricted to the first or second area excluding the area transgressing beyond the dividing line. This definition of the search area also reduces the risk of attribution of a micronucleus to an incorrect nucleus.

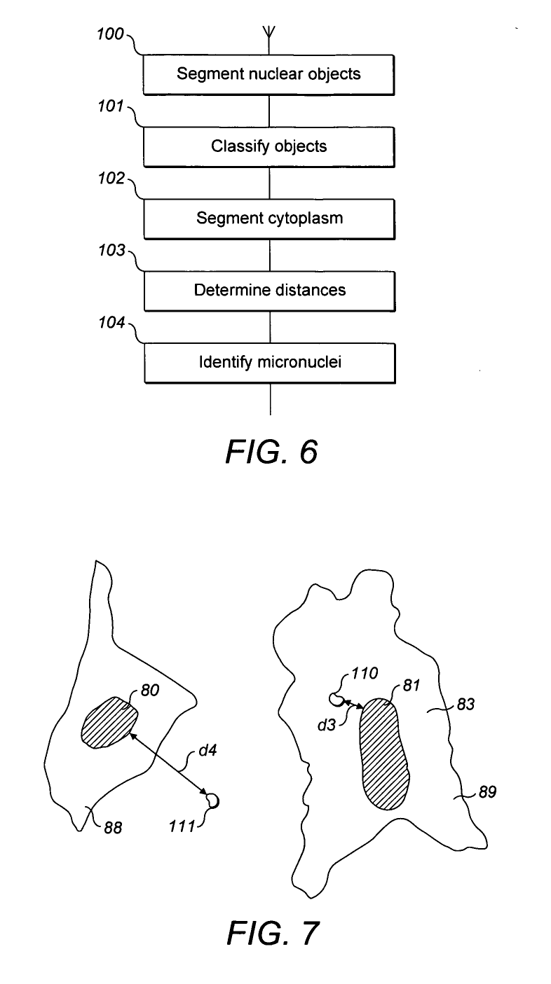

FIG. 6 shows a flow diagram of a method of processing an input image of a biological specimen according to the second preferred embodiment. The image being processed is taken from the channel pertaining to the fluorophore used to label DNA. In the first step 100 the nuclear objects are segmented. The segmentation may be carried out using thresholding. The threshold for the intensity is set by the operator of the analyzer system at a value that clearly reveals the nuclei and micronuclei. An object is labelled as a nuclear object when it has an intensity above the threshold intensity and a size larger than a set threshold size. FIG. 7 shows four nuclear objects 80, 81, 110 and 111.

The second step 101 classifies the objects according to their size and form factor. Objects having a size above an operator-set threshold are classified as nuclei, those having a size below the threshold as potential micronuclei. The threshold may have the value of one third of the average size of a nucleus. The nuclei can be further classified according to their form. The operator may use a plot of the form factor versus the intensity to set the threshold at the optimum value. FIG. 7 shows two nuclei 80 and 81, the first one mononucleate and the second one binucleate, and two potential micronuclei 110 and 111.

In a third, optional, step 102 the cytoplasm is segmented in a way as described in the third step 72 of FIG. 4.

The fourth step 103 determines the distances between the micronuclei and the nuclei. The determination of the distance may be carried out by dilating the edge of the potential micronucleus, until one of the pixels in the dilating edge overlaps an object classified as a nucleus; the distance can be taken as the distance from the overlapping pixel to the edge or the centre of the micronucleus. FIG. 7 shows the distance d3 between potential micronucleus 110 and the nearest nucleus 81 and the distance d4 between potential micronucleus 111 and the nearest nucleus 80. Alternatively a bounding box, circle or polygon may be applied to the potential micronucleus and enlarged in pixel increments to determine the distance to neighbouring nuclei by expansion of the bounding shape until it overlaps an object classified as a nucleus. In a further variation the dilation of the area around the potential micronucleus, and hence the search for the nearest nucleus of this micronucleus, is stopped when the distance between the edge of the potential micronucleus and the edge of the dilated area is equal to the search distance.

If the extent of the cytoplasm has been determined, the search can be refined. An overlay of the cytoplasm and the micronuclei allows the exclusion of potential micronuclei that are located outside the cytoplasm, such as potential micronucleus 111 in FIG. 7. In that case only potential micronucleus 110 in FIG. 7 will be used in the subsequent processing of the image.

Similarly, potential micronuclei in areas having a high density of cells may be excluded from the search because of the increased risk of false identification. Dead cells may also be excluded in a way as described for the method of FIG. 4.

In the fifth step 104 the micronuclei are identified. When the distance between a potential micronucleus and the nearest nucleus is less than the search distance, the potential micronucleus is annotated as micronucleus. When the distance is larger, the potential micronucleus will not be annotated. The search distance is determined as set out in the fourth step 73 of the method shown in FIG. 4. The micronucleus can be attributed to the nearest nucleus. Also when the nuclei are relatively close together, the method automatically attributes the micronucleus to the nearest nucleus.

The attribution may be refined by finding the nearest nucleus and the next nearest nucleus. The micronucleus is now attributed to the weighted nearest nucleus, where the weighing is according to the integrated intensity of the cytoplasm of the nucleus. The larger the extent of the cytoplasm, the more likely it contains the micronucleus.

Although the above methods use thresholding as segmentation method, other methods of segmentation such as the top-hat transform may also be used. Similarly, the second embodiment is not restricted to the disclosed methods of determining the distance between a micronucleus and a nucleus.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of processing an image of a biological sample containing nuclei, cytoplasm and micronuclei, each of the nuclei being surrounded by cytoplasm, the cytoplasm having a maximum distance, which is the largest extent of the cytoplasm from its nucleus occurring in the image, the method comprising the steps of:
setting a search distance at a value less than the maximum distance;
searching for micronuclei within the search distance from the nuclei; and
annotating the micronuclei found in the search.

2. The method of claim 1, further including the step of defining a first area around at least one of the nuclei, the first area being enclosed between an inner boundary and an outer boundary, the distance between an edge of the first element and the outer boundary being substantially equal to the search distance, and the search for micronuclei being carried out within a search area restricted by the first area.

3. The method of claim 2, wherein the inner boundary is the edge of the nucleus.

4. The method of claim 2, wherein the inner boundary of the first area is arranged outside the nucleus and inside the outer boundary.

5. The method of claim 2, further including the step of defining a second area around the nucleus, the second area being a region of overlap of the first area and the area of the cytoplasm surrounding the nucleus, the search area being restricted by the second area.

6. The method of claim 2, wherein the search area is restricted to the first area excluding the region of overlap with neighbouring nuclei.

7. The method of claim 5, wherein the search area is restricted to the second area excluding the region of overlap with neighbouring nuclei.

8. The method of claim 1, further including the steps of:
determining a third distance between at least one of the micronuclei and the nearest nucleus,
whereas the micronucleus is only annotated when the third distance is less than the search distance.

9. The method of claim 8, whereas the micronucleus is only annotated when the third distance is less than the search distance and when the micronucleus overlaps the cytoplasm surrounding the nearest nucleus.

10. The method of claim 1, further including the step of excluding clusters of nuclei from searching.

11. The method of claim 1, wherein the search is restricted to nuclei located in a living cell.

12. A computer programme arranged to perform the method of claim 1.

13. A data carrier in which the computer programme of claim 12 is stored.

14. A system including a processing unit for running the programme of claim 12.
